(19) United States
(12) Patent Application Publication
(10) Pub. No.: US 2026/0181672 A1
(43) Pub. Date: Jun. 25, 2026

(54) PHYSICAL SIDELINK FEEDBACK CHANNEL RESOURCE CONFIGURATION

(71) Applicant: LENOVO (SINGAPORE) PTE. LTD., Singapore (SG)

(72) Inventors: Karthikeyan Ganesan, Nauheim (DE); Alexander Golitschek Edler von Elbwart, Darmstadt (DE)

(73) Assignee: Lenovo (Singapore) Pte. Limited, Singapore (SG)

(21) Appl. No.: 19/125,685

(22) PCT Filed: Oct. 31, 2023
(86) PCT No.: PCT/IB2023/060980

§ 371 Date: Apr. 29, 2025

Related U.S. Application Data
(60) Provisional application No. 63/422,735, filed on Nov. 4, 2022.

(51) Int. Cl. H04W 72/25; H04W 74/0808

(52) U.S. Cl. CPC H04W 72/25; H04W 74/0808

(57) ABSTRACT

Various aspects of the present disclosure relate to an apparatus for physical sidelink feedback channel (PSFCH) resource configuration. The apparatus, such as a sidelink transmitting UE, receives a configuration indicating multiple PSFCH occasions per physical sidelink shared channel (PSSCH) transmission in a resource pool, where the multiple PSFCH occasions are each configurable in more than one resource block (RB) set. The apparatus transmits a sidelink communication to a receiving UE based at least in part on a determination to transmit in a PSFCH occasion according to the PSSCH transmission in a RB set.

### RELATED APPLICATION

This application claims priority to U.S. Provisional Application Ser. No. 63/422,735 filed Nov. 4, 2022 entitled “Physical Sidelink Feedback Channel Resource Configuration,” the disclosure of which is incorporated by reference herein in its entirety.

### TECHNICAL FIELD

The present disclosure relates to wireless communications, and more specifically to physical sidelink feedback channel (PSFCH) resource configuration.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, sidelink unlicensed operation continues to develop. The sidelink operation for communication is developing for transmission over the unlicensed spectrum of channels, such as the physical uplink shared channel (PUSCH) and the physical uplink control channel (PUCCH).

### SUMMARY

The present disclosure relates to methods, apparatuses, and systems that support PSFCH resource configuration. By utilizing the described techniques, more than one PSFCH occasion per physical sidelink control channel (PSCCH) and physical sidelink shared channel (PSSCH) transmission is supported. Accordingly, more than one PSFCH resource occasion is configurable in combination with frequency division multiplexing (FDM) and time division multiplexing (TDM) by using more than one listen before talk (LBT) sub-band (i.e., wideband PSFCH configuration and more than one time domain PSFCH occasion for each PSSCH transmission). Implementations include PSFCH resource configuration in each LBT sub-band for each PSFCH occasion, and PSFCH resource configuration in at least a LBT sub-band for each PSFCH occasion, such as for choosing LBT sub-bands for alternate PSFCH occasions.

Further, since PSFCH resources are configured in more than one resource block (RB) set for each PSSCH transmission, consideration is given as to how to determine the PSFCH resource in RB sets, considering where PSSCH was transmitted in the RB set and the PSSCH to PSFCH timings. Additionally, when LBT is successful in more than one RB set, transmit PSFCH according to the transmit (Tx) power availability at a UE, and in this case, prioritize PSFCH transmission in the RB set where PSSCH was transmitted or the lowest RB set. Accordingly, more than one PSFCH occasion per PSSCH transmission provides more opportunities to transmit PSFCH according to the LBT outcome, since the LBT is performed in each LBT sub-bands based on configured resources.

In some implementations of the method and apparatuses described herein, a sidelink transmitting UE receives a configuration indicating multiple PSFCH occasions per PSSCH transmission in a resource pool, the multiple PSFCH occasions each configurable in more than one RB set. The sidelink transmitting UE transmits a sidelink communication to a receiving UE based at least in part on a determination to transmit in a PSFCH occasion according to the PSSCH transmission in a RB set.

Some implementations of the method and apparatuses described herein may further include the multiple PSFCH occasions are each configurable in more than one RB set in a frequency domain. The multiple PSFCH occasions are each configurable in more than one RB set according to FDM. The multiple PSFCH occasions are each configurable in more than one RB set in a time domain. The multiple PSFCH occasions are each configurable in more than one RB set according to TDM. The multiple PSFCH occasions are each configurable in more than one RB set according to FDM and TDM using more than one LBT sub-band. The multiple PSFCH occasions are each configurable in more than one RB set in a frequency domain and a time domain. The determination to transmit in the PSFCH occasion is according to the PSSCH transmission in the RB set, a slot index, and a subchannel index. The sidelink transmitting UE transmits to the receiving UE based on the determination to transmit in the PSFCH occasion in at least one RB set in a frequency domain according to a LBT result of the PSFCH transmission. The sidelink transmitting UE transmits to the receiving UE based on the determination to transmit in the PSFCH occasion in a lowest RB set index based on successful LBT for more than one RB set.

In some implementations of the method and apparatuses described herein, a sidelink receiving UE transmits a configuration indicating multiple PSFCH occasions per PSSCH transmission in a resource pool, where the multiple PSFCH occasions are each configurable in more than one RB set. The sidelink receiving UE receives a sidelink communication from a transmitting UE based on a determination at the transmitting UE to transmit in a PSFCH occasion according to the PSSCH transmission in a RB set.

Some implementations of the method and apparatuses described herein may further include the multiple PSFCH occasions are each configurable in more than one RB set in a frequency domain. The multiple PSFCH occasions are each configurable in more than one RB set according to FDM. The multiple PSFCH occasions are each configurable in more than one RB set in a time domain. The multiple PSFCH occasions are each configurable in more than one RB set according to TDM. The multiple PSFCH occasions are each configurable in more than one RB set according to FDM and TDM using more than one LBT sub-band. The multiple PSFCH occasions are each configurable in more than one RB set in a frequency domain and a time domain. The determination to transmit in the PSFCH occasion is according to the PSSCH transmission in the RB set, a slot index, and a subchannel index.

### BRIEF DESCRIPTION OF THE DRAWINGS

FIG. 1 illustrates an example of a wireless communications system that supports PSFCH resource configuration in accordance with aspects of the present disclosure.

FIG. 2 illustrates an example of NR sidelink design, as related to PSFCH resource configuration in accordance with aspects of the present disclosure.

FIG. 3 illustrates an example of long term evolution (LTE) interlacing, as related to PSFCH resource configuration in accordance with aspects of the present disclosure.

FIG. 4 illustrates an example of PSFCHs for hybrid automatic repeat request (HARQ) feedback associated with different transmissions, which supports PSFCH resource configuration in accordance with aspects of the present disclosure.

FIG. 5 illustrates an example of configuring PSFCH resource in each RB set, which supports PSFCH resource configuration in accordance with aspects of the present disclosure.

FIG. 6 illustrates an example of configuring multiple PSFCH occasions per PSSCH transmission in a resource pool, which supports PSFCH resource configuration in accordance with aspects of the present disclosure.

FIG. 7 illustrates an example of multiple PSFCH occasions for each PSSCH transmission with different frequency domain location in each occasion, which supports PSFCH resource configuration in accordance with aspects of the present disclosure.

FIGS. 8 and 9 illustrate an example of a block diagram of devices that supports PSFCH resource configuration in accordance with aspects of the present disclosure.

FIGS. 10-12 illustrate flowcharts of methods that support PSFCH resource configuration in accordance with aspects of the present disclosure.

### DETAILED DESCRIPTION

A wireless communications system includes sidelink unlicensed operation for device communication, facilitating transmission over the unlicensed spectrum of channels, such as the PUSCH and the PUCCH. Transmission for sidelink unlicensed operation over PUSCH and PUCCH format 2, should meet the power spectral density (PSD) regulation and minimum channel occupancy (e.g., 80%). To meet these regulations, interlacing methods were defined in LTE-unlicensed and NR-unlicensed by interlacing PUSCH and PUCCH channels at the resource block level. Sub-physical resource block (PRB) based interlacing was also considered for higher sub carrier spacing (SCS).

For sidelink resource allocation, the minimum scheduling unit is defined by a sub-channel consisting of ‘N’ PRBs, and ‘M’ sub-channels constitute a resource pool. Each sidelink (SL) carrier contains one SL bandwidth part (BWP) which is then associated with multiple transmit (Tx) resource pools containing different configurations of the sub-channel sizes {n10, n12, n15, n20, n25, n50, n75, n100}. The minimum scheduling unit of a sub-channel for sidelink contradicts that of uplink, which is based on a RB level scheduling unit and each resource pool in sidelink does not span across an entire bandwidth or LBT sub-bands, which is the requirement from minimum occupancy and PSD limit.

Hence, in new radio (NR) a sidelink-unlicensed (SL-U) study introduces interlacing for the data and feedback channel to meet the regulatory requirements of PSD and the minimum channel occupancy (e.g., 80%), and a sidelink unlicensed operation studying a new interlacing method by considering the traditional sidelink design of sub-channels and resource pools. To avoid PSFCH dropping due to LBT failures, many PSFCH occasions can be configured corresponding to each PSSCH transmission. Challenges include how to configure the PSFCH resource occasion in time domain, as well for wideband (i.e., in one or more LBT sub-bands), and how to determine the PSFCH resource corresponding to the PSSCH transmission.

In aspects of PSFCH resource configuration, this disclosure describes details for more than one PSFCH occasion per PSCCH and PSSCH transmission. Accordingly, more than one PSFCH resource occasion is configurable in combination with FDM and TDM by using more than one LBT sub-band (i.e., wideband PSFCH configuration and more than one time domain PSFCH occasion for each PSSCH transmission). Implementations include PSFCH resource configuration in each LBT sub-band for each PSFCH occasion, and PSFCH resource configuration in at least a LBT sub-band for each PSFCH occasion, such as for choosing LBT sub-bands for alternate PSFCH occasions.

Further, since PSFCH resources are configured in more than one RB set for each PSSCH transmission, consideration is given as to how to determine the PSFCH resource in RB sets, considering where PSSCH was transmitted in the RB set and the PSSCH to PSFCH timings. Additionally, when LBT is successful in more than one RB set, transmit PSFCH according to the transmit (Tx) power availability at a UE, and in this case, prioritize PSFCH transmission in the RB set where PSSCH was transmitted or the lowest RB set. Accordingly, more than one PSFCH occasion per PSSCH transmission provides more opportunities to transmit PSFCH according to the LBT outcome, since the LBT is performed in each LBT sub-bands based on configured resources.

Aspects of the present disclosure are described in the context of a wireless communications system. Aspects of the present disclosure are further illustrated and described with reference to device diagrams and flowcharts.

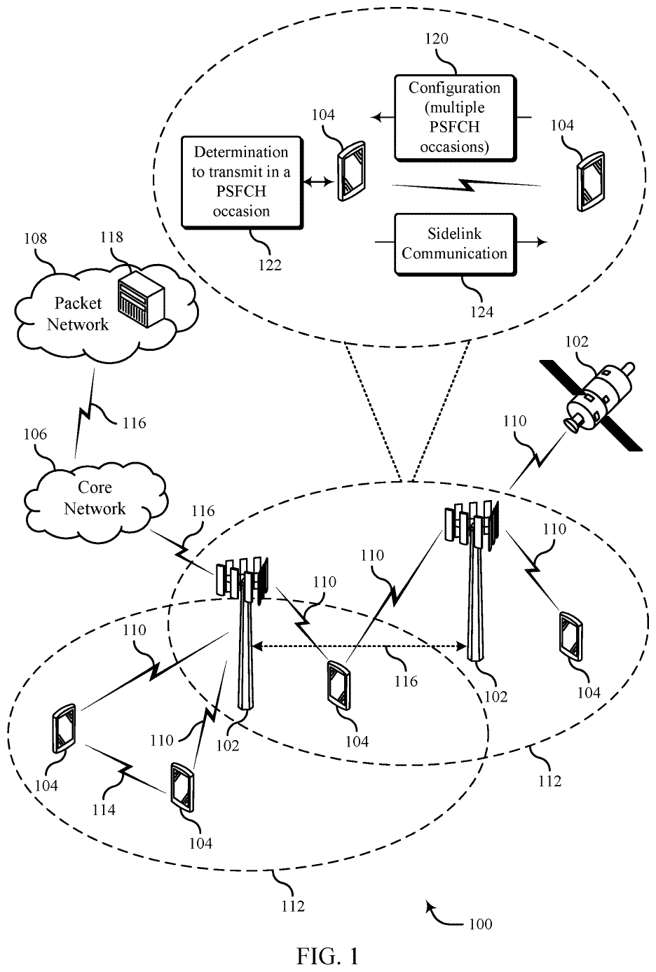

FIG. 1 illustrates an example of a wireless communications system 100 that supports PSFCH resource configuration in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6 or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, the UEs 104 are operable to implement various aspects of PSFCH resource configuration, as described herein. For instance, a first UE (e.g., sidelink receiving UE) transmits a configuration 120 indicating multiple PSFCH occasions per PSSCH transmission in a resource pool, where the multiple PSFCH occasions are each configurable in more than one RB set. A second UE (e.g., a sidelink transmitting UE) receives the configuration 120 indicating the multiple PSFCH occasions per PSSCH transmission in a resource pool. The second UE (e.g., the sidelink transmitting UE) processes a determination 122 to transmit in a PSFCH occasion according to the PSSCH transmission in a RB set. The second UE (e.g., the sidelink transmitting UE) then transmits a sidelink communication 124 to the first UE, which the first UE (e.g., the sidelink receiving UE) receives.

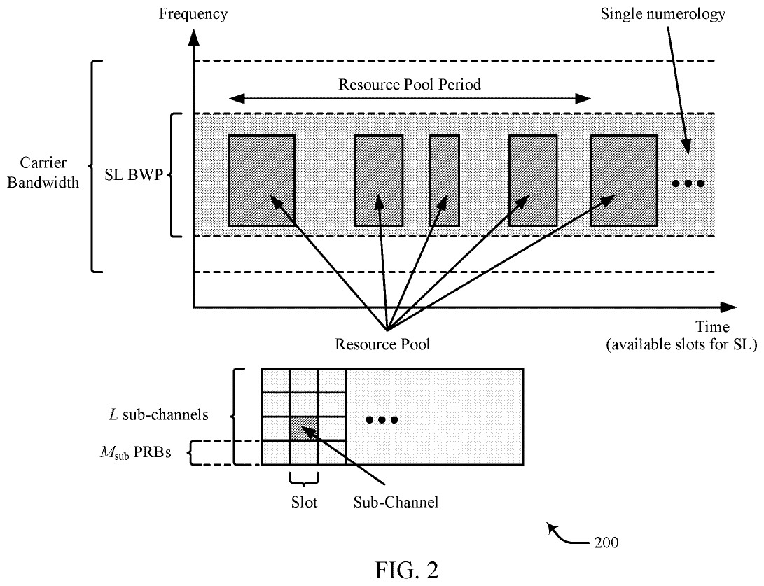

FIG. 2 illustrates an example 200 of NR sidelink design, as related to PSFCH resource configuration described herein. With reference to NR sidelink design, a resource pool structure is defined within the SL BWP in a SL carrier. One or more resource pool structure (pre) configurations contain a subchannel size, and a bitmap of time slot and frequency resource, as shown in the example 200.

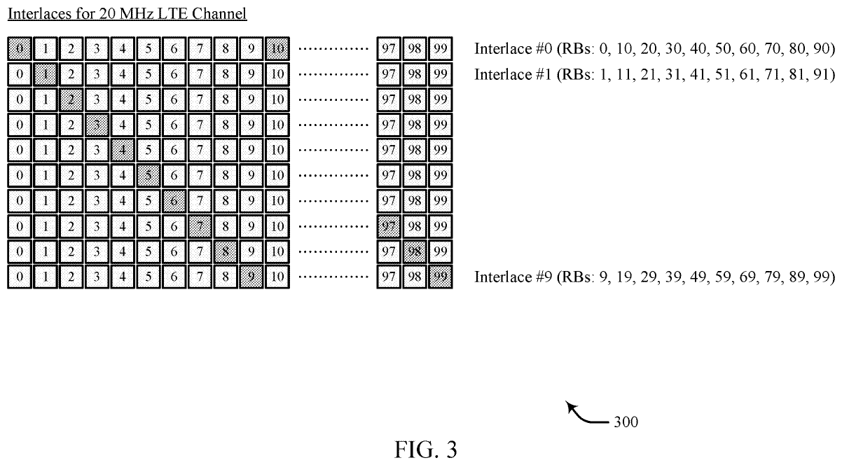

FIG. 3 illustrates an example 300 of long term evolution (LTE) interlacing, as related to PSFCH resource configuration described herein. With reference to the interlace design for Uu interface, LTE-license assisted access (LAA) and NR-unlicensed operation intended to meet the PSD regulation and minimum channel occupancy (e.g., 80%). As shown in the example 300, for a 20 MHz wide LTE channel, corresponding to 100 RB, there are ten interlaces with 10 RB per interlace. For example, interlace #0 contains resource blocks {0, 10, 20, 30, 40, 50, 60, 70, 80, 90}.

With reference to Rel18 agreements on SL-U, an agreement for PSCCH and PSSCH in SL-U is that both R16/R17 NR SL contiguous RB-based and interlace RB-based transmissions similar to R16 NR-U are supported. In another agreement for PSCCH and PSSCH in SL-U, and for interlace RB-based transmission, the frequency domain resource allocation granularity is one sub-channel for PSSCH transmission, where one sub-channel equals K interlace and for further study (FFS), a determination as to whether K is fixed as 1 or (pre-)configured. Further determination as to whether one or both of the following alternatives are supported: Alt 1, 1 sub-channel is confined within 1 RB set; and Alt 2:1 sub-channel spans 1 or multiple RB set(s) belonging to a resource pool.

In another agreement, to meet occupied channel bandwidth (OCB) and PSD requirement for PSFCH transmission, at least RB-based interlace is supported at least for 15 kHz and 30 kHz SCS. In another agreement for PSFCH and SL-HARQ in SL-U, at least R16 NR SL PSFCH format 0 is supported, and for FFS, a determination as to whether to introduce a new PSFCH format. Further, a determination as to how to meet OCB and PSD requirement for PSFCH transmission (e.g., using interlaced RB transmission, and whether or how to avoid too small PSFCH capacity, etc.). Further, a determination as to the locations of PSFCH resources (e.g., (pre-)configured, dynamically indicated, etc.). Further, a determination as to whether or how to address PSFCH transmission dropping due to LBT failure (e.g., whether to have multiple PSFCH occasions for a PSSCH and the related PSSCH-PSFCH mapping relationship, impact on SL hybrid automatic repeat request-acknowledgement (HARQ-ACK) reporting to the gNB for Mode 1, etc.). Further, a determination as to whether or how to address PSFCH and related PSSCH in different channel occupancy times (COTs).

In another agreement regarding PSFCH transmission, at least the followings alternatives can be further studied: Alt 1 for each PSFCH transmission occupies a common interlace and zero or one or more dedicated PRB(s); Alt 2 for each PSFCH transmission occupies an interlace, and may or may not further apply code domain enhancement (e.g., orthogonal cover code (OCC), PRB-level cyclic shifts); Alt 3 for each PSFCH transmission occupies some dedicated PRBs and some common PRBs; and FFS details of the alternatives.

In another agreement, if RANI decides that LBT is performed for PSFCH transmission, for the time and frequency domain locations of PSFCH resources, at least the followings alternatives can be further studied: Alt 1 for PSFCH resources are (pre-)configured; Alt 2 for PSFCH resources are dynamically indicated; a combination of above alternatives are not precluded; and FFS details of the above alternatives.

In another agreement for interlace RB-based PSCCH and PSSCH transmission in SL-U, regarding 1 sub-channel equals K interlace(s), at least K=1 and K=2 is supported for 15 kHz SCS; at least K=1 is supported for 30 kHz SCS; and for FFS, details related to multiple RB sets. In another agreement regarding frequency domain resource indication for interlace RB-based PSSCH transmission, when more than one RB set is used for transmissions, down-select one of the following options: option A to support that the used interlace index(s) in different RB sets are always the same; or option B to support that the used interlace index(s) in different RB sets can be different.

In another agreement regarding frequency domain resource indication for interlace RB-based PSSCH transmission, down-select one of the following options: option 1 to support explicitly indicating the used sub-channel index(s) and RB set index(s); or option 2 to support explicitly indicating at least the used sub-channel index(s) (at least RB set index(s) is not explicitly indicated). In another agreement, at least there is 1 PSFCH occasion per PSCCH and PSSCH transmission.

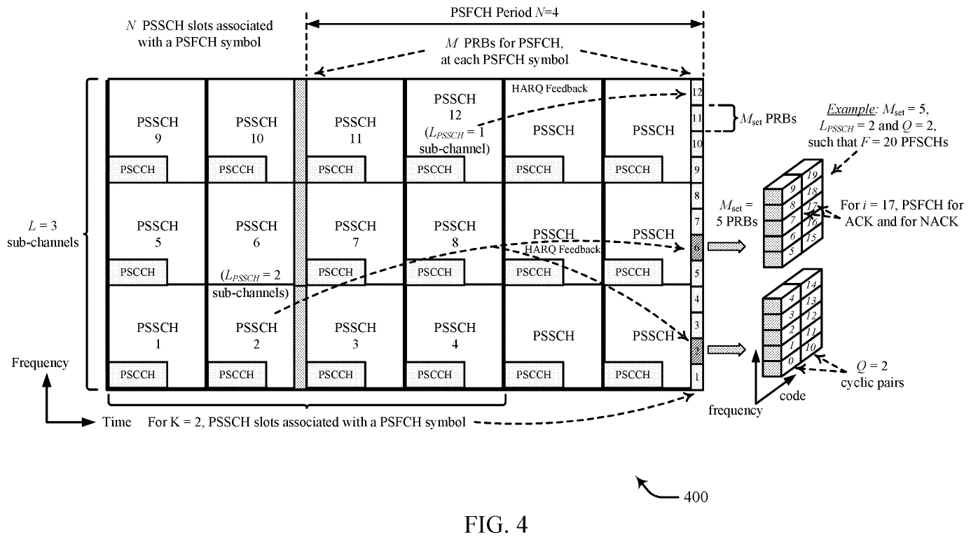

FIG. 4 illustrates an example 400 of PSFCHs for HARQ feedback associated with different transmissions, which supports PSFCH resource configuration as described herein. In another agreement to address PSFCH transmission dropping due to LBT failure, the following are considered: Alt 1 to support more than 1 PSFCH occasion per PSCCH and PSSCH transmission; Alt 2 for PSFCH resources are dynamically indicated; Alt 3 to convey SL-HARQ feedback information in PSCCH PSSCH (e.g., new sidelink control information (SCI) or new medium access control element (MAC-CE)); Alt 4 to drop PSFCH transmission; Alt 5 to support trigger based HARQ feedback reporting for non-numerical HARQ FB and one shot HARQ FB; any combination of above alternatives are not precluded; and FFS details of the above alternatives.

In aspects of PSFCH resource configuration, more than one PSFCH occasion per PSCCH and PSSCH transmission is supported. Accordingly, more than one PSFCH resource occasion is configurable in combination with FDM and TDM by using more than one LBT sub-band (i.e., wideband PSFCH configuration and more than one time domain PSFCH occasion for each PSSCH transmission). Implementations include PSFCH resource configuration in each LBT sub-band for each PSFCH occasion, and PSFCH resource configuration in at least a LBT sub-band for each PSFCH occasion, such as for choosing LBT sub-bands for alternate PSFCH occasions.

Further, since PSFCH resources are configured in more than one RB set for each PSSCH transmission, consideration is given as to how to determine the PSFCH resource in RB sets, considering where PSSCH was transmitted in the RB set and the PSSCH to PSFCH timings. Additionally, when LBT is successful in more than one RB set, transmit PSFCH according to the transmit (Tx) power availability at a UE, and in this case, prioritize PSFCH transmission in the RB set where PSSCH was transmitted or the lowest RB set. Accordingly, more than one PSFCH occasion per PSSCH transmission provides more opportunities to transmit PSFCH according to the LBT outcome, since the LBT is performed in each LBT sub-bands based on configured resources.

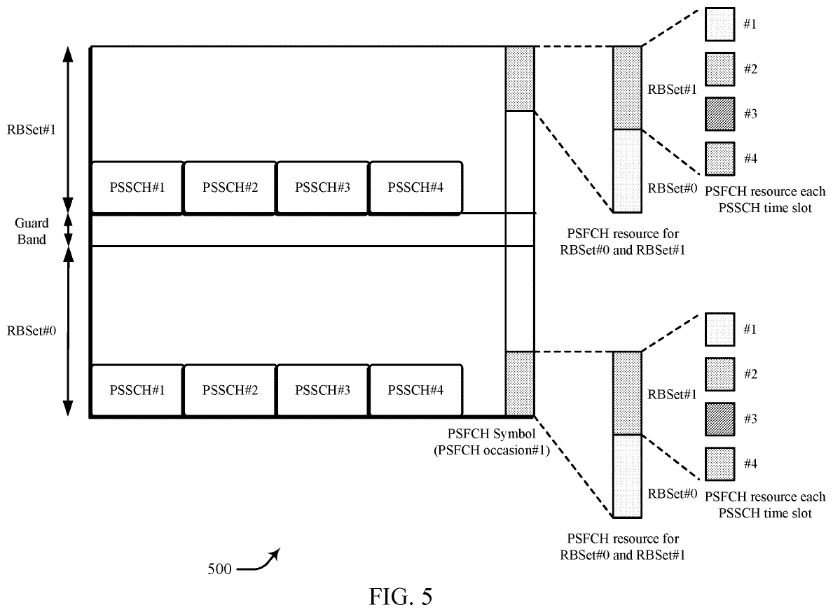

FIG. 5 illustrates an example 500 of configuring PSFCH resource in each RB set, which supports PSFCH resource configuration as described herein. In an implementation, multiple PSFCH occasions per PSSCH transmission can be configured in a resource pool containing one or more RB sets. However, a PSFCH resource occasion can be configured in combination with FDM, TDM, or in a combination of FDM and TDM. Each PSFCH resource occasion can be configured in more than one RB set, which means that when PSSCH is transmitted in RBset #0, the associated PSFCH occasions can be configured in both RBset #0 and RBset #1, as shown in this example 500.

A UE can be implemented to select to transmit PSFCH in a RBset where LBT is successful. For example, when LBT Is successful only in RBset #0, then the PSFCH feedbacks correspond to PSSCH transmission happening in RBset #0, and the RBset #0 can be transmitted in a PSFCH resource in RBset #0. Further, a UE can be implemented to select to transmit PSFCH in one of the RB sets where LBT is successful in more than one RB set. In an implementation, PSFCH is transmitted in the lowest RB set index, and in another implementation, PSFCH is transmitted in a RB set where the associated PSSCH was transmitted. For example, if PSSCH is transmitted in RBset #1, then the associated PSFCH is transmitted in the RBset #1.

A resource pool can be configured with K interlacing for PSFCH for one PSSCH subchannel. When one or more PSFCH interlaces are configured for one PSSCH subchannel, the interlaces of each subchannel can be in multiple RB sets, which means one or more interlaces of the PSFCH are configured within RBset #0 and one or more interlaces of the PSFCH are configured within RBset #1 for each PSSCH subchannel. For example, when one PSSCH subchannel equals k=4 PSFCH interlace, two PSFCH interlaces are in RBset #0 and two interlaces are in RBset #1. These two PSFCH interlaces can contain PSFCH occasion for RBset #0 and RBset #1 in each RB set. When PSSCH is transmitted in RBset #0, the associated PSFCH occasions contain one or more PSFCH interlaces in RBset #0 and RBset #1, as shown in this example 500.

In implementations, one subchannel of PSSCH equals k=4 PSFCH interlaces, where one PSFCH interlace index is associated to one PSSCH slot index and each PSFCH interlace contains Mset PRBs to transmit HARQ feedback for one PSSCH transmission. In this case for unicast HARQ-ACK, the HARQ-ACK is repeated in all PRBs within the interlace to meet the OCB requirement. For groupcast option 2 HARQ-ACK, the HARQ-ACK feedbacks of member UEs occupy all PRBs within the interlace using the frequency domain first and code domain second approach. For groupcast option 1 HARQ-ACK, the HARQ-ACK of a common resource is repeated in all PRBs within the interlace. In another implementation, one subchannel of PSSCH equals K=1 PSFCH interlaces, which means one PSFCH interlace index is associated to N PSSCH slots and each PSFCH interlace contains Mset PRBs to transmit HARQ feedback for one PSSCH transmission in a time slot.

Each PSFCH interlace contains N*Mset of PRBs, where N is the number of PSSCH slots and one PSSCH transmission in a time slot is associated to one Mset of PSFCH resource within the interlace. In this case, for unicast HARQ, the HARQ feedback is repeated in all Mset PRBs to meet the OCB requirement. For groupcast option 2 HARQ-ACK, the HARQ-ACK feedback of member UEs is transmitted in all Mset PRBs within the interlace using the frequency domain first and code domain second approach. For groupcast option 1, the HARQ-ACK of common non-acknowledgement (NACK) resource is repeated in all Mset PRBs within the interlace. If feedback is not available for transmission in the PSFCH resource, for example due to SCI decoding failure or due to groupcast option 1 where common NACK resource is provided and the PSFCH is not transmitted to decoding success, to meet the OCB requirement, either ACK or NACK is transmitted in the corresponding feedback resource.

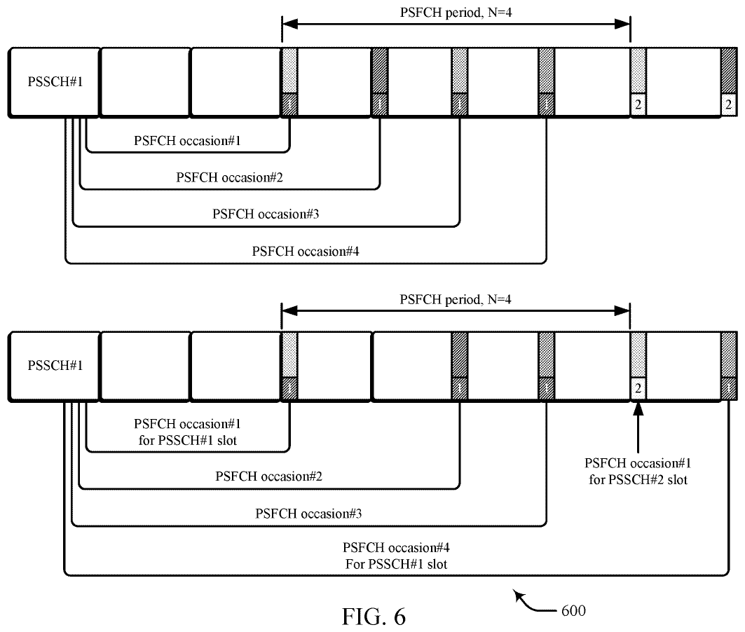

FIG. 6 illustrates an example 600 of configuring multiple PSFCH occasions per PSSCH transmission in a resource pool, which supports PSFCH resource configuration as described herein. When multiple PSFCH occasions per PSSCH transmission are configured, then each of these PSFCH occasions can be configured to transmit PSFCH with the same HARQ timeline (i.e., PSSCH-PSFCH feedback timing). The multiple PSFCH occasions per PSSCH transmission can be separately configured in a resource pool compared to the existing PSFCH period, N, where N=2, 4, 8, etc. In such a case, the PSFCH period can be calculated from the first PSFCH occasions in a resource pool. Further, multiple PSFCH occasions per PSSCH transmission can be configured within the next PSFCH period, as shown in the example 600, where HARQ feedback generated for the first PSFCH period may be repeated in the multiple next PSFCH occasions without multiplexing new HARQ feedback generated from other PSSCHs. Additionally, multiple PSFCH occasions per PSSCH transmission can span across periods so that when LBT is successful, the UE may transmit feedbacks for previous PSFCH occasion and new PSFCHs.

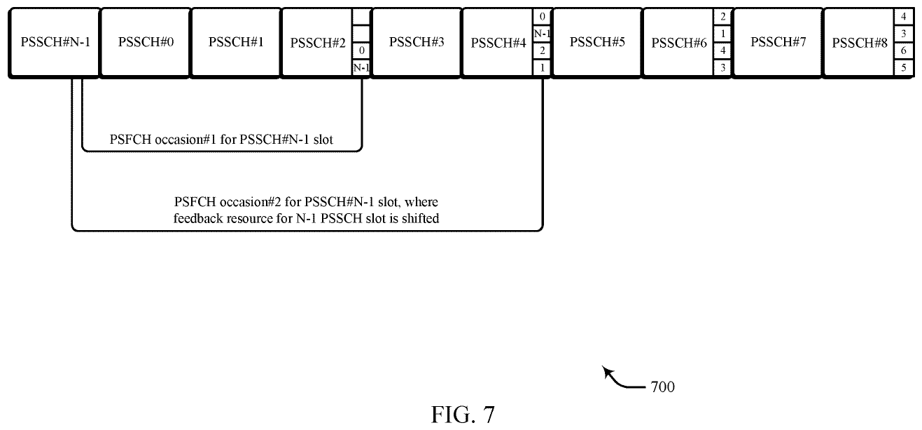

FIG. 7 illustrates an example 700 of multiple PSFCH occasions for each PSSCH transmission with different frequency domain location in each occasion, which supports PSFCH resource configuration as described herein. In another implementation, multiple PSFCH occasions for each PSSCH transmission with different frequency domain locations of Mset PRBs in each PSFCH occasion are as shown in this example 700, where the HARQ feedbacks for next PSSCH slots are multiplexed in the next PSFCH occasions. The number of PSFCH resources per PSFCH occasion can be calculated by multiplying the periodicity of PSFCH with that of number of PSFCH occasions per PSSCH transmission. In another implementation, HARQ feedbacks of next PSSCH slots may be multiplexed in each occasions with same frequency domain location. In one or more implementations, a combination of frequency domain PSFCH resource configurations in more than one RBset, more than one time domain occasion per PSSCH transmission, and more than one code domain (additional OCC configuration per PSSCH transmission) is implemented to provide additional PSFCH resources per PSSCH transmission.

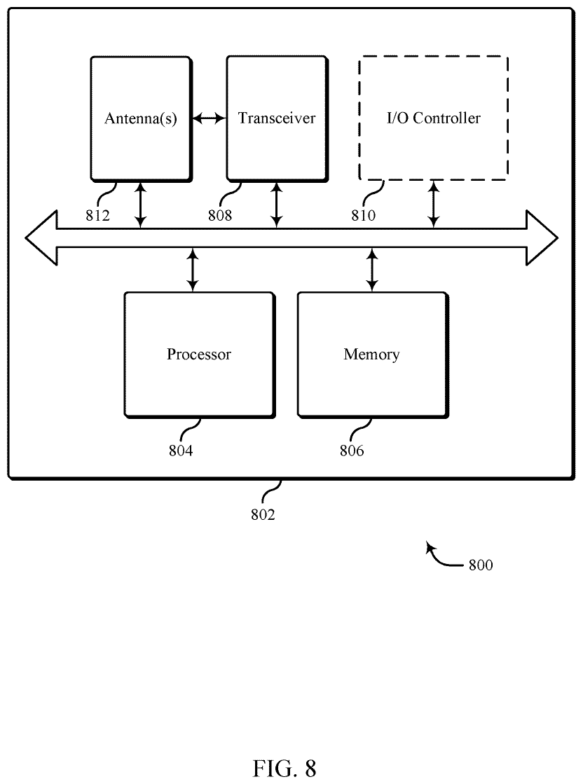

FIG. 8 illustrates an example of a block diagram 800 of a device 802 that supports PSFCH resource configuration in accordance with aspects of the present disclosure. The device 802 may be an example of a UE 104, such as a sidelink transmitting UE, as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. The processor 804 may be configured as or otherwise support a means for receiving a configuration indicating multiple PSFCH occasions per PSSCH transmission in a resource pool, the multiple PSFCH occasions each configurable in more than one RB set; and transmitting a sidelink communication to a receiving UE based at least in part on a determination to transmit in a PSFCH occasion according to the PSSCH transmission in a RB set.

Additionally, the processor 804 may be configured as or otherwise support any one or combination of the multiple PSFCH occasions are each configurable in more than one RB set in a frequency domain. The multiple PSFCH occasions are each configurable in more than one RB set according to FDM. The multiple PSFCH occasions are each configurable in more than one RB set in a time domain. The multiple PSFCH occasions are each configurable in more than one RB set according to TDM. The multiple PSFCH occasions are each configurable in more than one RB set according to FDM and TDM using more than one LBT sub-band. The multiple PSFCH occasions are each configurable in more than one RB set in a frequency domain and a time domain. The determination to transmit in the PSFCH occasion is according to the PSSCH transmission in the RB set, a slot index, and a subchannel index. The method further comprising transmitting to the receiving UE based at least in part on the determination to transmit in the PSFCH occasion in at least one RB set in a frequency domain according to a LBT result of the PSFCH transmission. The method further comprising transmitting to the receiving UE based at least in part on the determination to transmit in the PSFCH occasion in a lowest RB set index based on successful LBT for more than one RB set.

Additionally, or alternatively, the device 802, in accordance with examples as disclosed herein, may include a processor and a memory coupled with the processor, the processor configured to cause the apparatus to receive a configuration indicating multiple PSFCH occasions per PSSCH transmission in a resource pool, the multiple PSFCH occasions each configurable in more than one RB set; and transmit a sidelink communication to a receiving UE based at least in part on a determination to transmit in a PSFCH occasion according to the PSSCH transmission in a RB set.

Additionally, the wireless communication at the device 802 may include any one or combination of the multiple PSFCH occasions are each configurable in more than one RB set in a frequency domain. The multiple PSFCH occasions are each configurable in more than one RB set according to FDM. The multiple PSFCH occasions are each configurable in more than one RB set in a time domain. The multiple PSFCH occasions are each configurable in more than one RB set according to TDM. The multiple PSFCH occasions are each configurable in more than one RB set according to FDM and TDM using more than one LBT sub-band. The multiple PSFCH occasions are each configurable in more than one RB set in a frequency domain and a time domain. The determination to transmit in the PSFCH occasion is according to the PSSCH transmission in the RB set, a slot index, and a subchannel index. The processor is configured to cause the apparatus to transmit to the receiving UE based at least in part on the determination to transmit in the PSFCH occasion in at least one RB set in a frequency domain according to a LBT result of the PSFCH transmission. The processor is configured to cause the apparatus to transmit to the receiving UE based at least in part on the determination to transmit in the PSFCH occasion in a lowest RB set index based on successful LBT for more than one RB set.

The processor 804 of the device 802, such as a UE 104, may support wireless communication in accordance with examples as disclosed herein. The processor 804 includes at least one controller coupled with at least one memory, and is configured to or operable to cause the processor to receive a configuration indicating multiple PSFCH occasions per PSSCH transmission in a resource pool, the multiple PSFCH occasions each configurable in more than one RB set; and transmit a sidelink communication to a receiving UE based at least in part on a determination to transmit in a PSFCH occasion according to the PSSCH transmission in a RB set.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

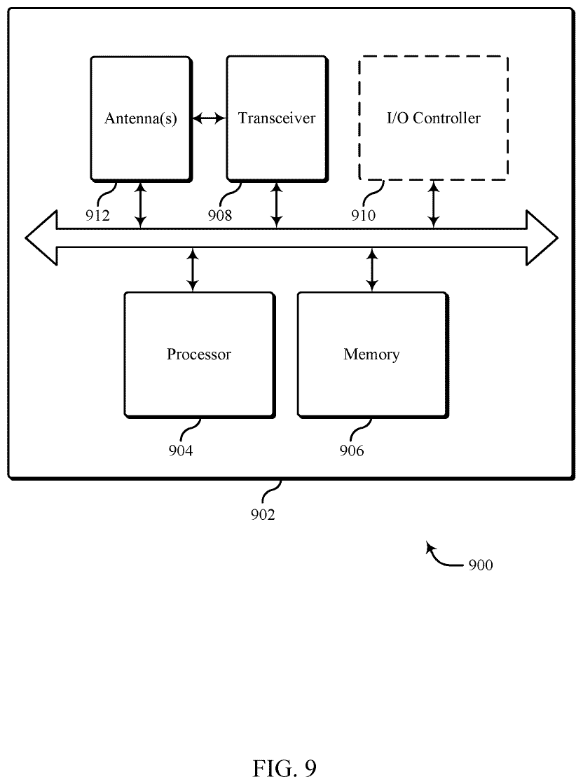

FIG. 9 illustrates an example of a block diagram 900 of a device 902 that supports PSFCH resource configuration in accordance with aspects of the present disclosure. The device 902 may be an example of a UE 104, such as a sidelink receiving UE, as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. The processor 904 may be configured as or otherwise support a means for transmitting a configuration indicating multiple PSFCH occasions per PSSCH transmission in a resource pool, the multiple PSFCH occasions each configurable in more than one RB set; and receiving a sidelink communication from a transmitting UE based at least in part on a determination at the transmitting UE to transmit in a PSFCH occasion according to the PSSCH transmission in a RB set.

Additionally, the processor 904 may be configured as or otherwise support any one or combination of multiple PSFCH occasions are each configurable in more than one RB set in a frequency domain. The multiple PSFCH occasions are each configurable in more than one RB set according to FDM. The multiple PSFCH occasions are each configurable in more than one RB set in a time domain. The multiple PSFCH occasions are each configurable in more than one RB set according to TDM. The multiple PSFCH occasions are each configurable in more than one RB set according to FDM and TDM using more than one LBT sub-band. The multiple PSFCH occasions are each configurable in more than one RB set in a frequency domain and a time domain. The determination to transmit in the PSFCH occasion is according to the PSSCH transmission in the RB set, a slot index, and a subchannel index.

Additionally, or alternatively, the device 902, in accordance with examples as disclosed herein, may include a processor and a memory coupled with the processor, the processor configured to cause the apparatus to: transmit a configuration indicating multiple PSFCH occasions per PSSCH transmission in a resource pool, the multiple PSFCH occasions each configurable in more than one RB set; and receive a sidelink communication from a transmitting UE based at least in part on a determination at the transmitting UE to transmit in a PSFCH occasion according to the PSSCH transmission in a RB set.

Additionally, the wireless communication at the device 902 may include any one or combination of the multiple PSFCH occasions are each configurable in more than one RB set in a frequency domain. The multiple PSFCH occasions are each configurable in more than one RB set according to FDM. The multiple PSFCH occasions are each configurable in more than one RB set in a time domain. The multiple PSFCH occasions are each configurable in more than one RB set according to TDM. The multiple PSFCH occasions are each configurable in more than one RB set according to FDM and TDM using more than one LBT sub-band. The multiple PSFCH occasions are each configurable in more than one RB set in a frequency domain and a time domain. The determination to transmit in the PSFCH occasion is according to the PSSCH transmission in the RB set, a slot index, and a subchannel index.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device 902. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

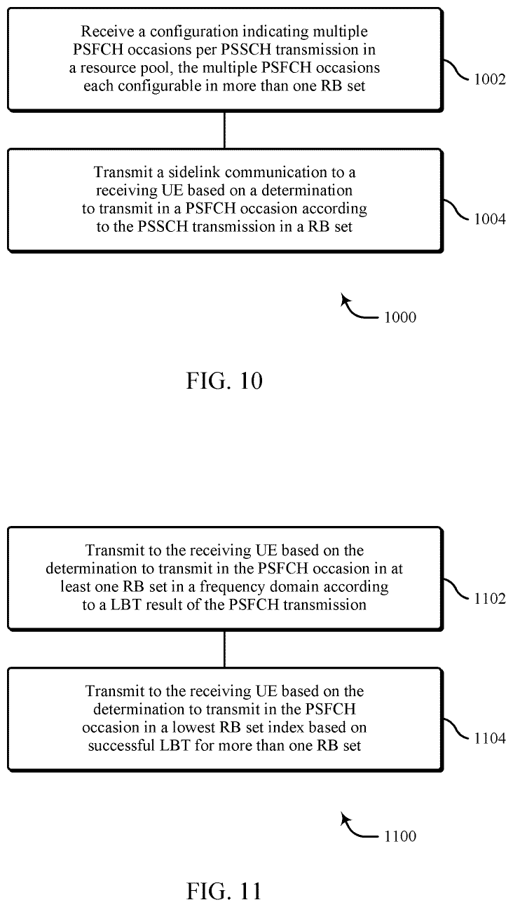

FIG. 10 illustrates a flowchart of a method 1000 that supports PSFCH resource configuration in accordance with aspects of the present disclosure. The operations of the method 1000 may be implemented by a device or its components as described herein. For example, the operations of the method 1000 may be performed by a UE 104, such as a sidelink transmitting UE, as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1002, the method may include receiving a configuration indicating multiple PSFCH occasions per PSSCH transmission in a resource pool, the multiple PSFCH occasions each configurable in more than one RB set. The operations of 1002 may be performed in accordance with examples as described herein. In some implementations, aspects of the operations of 1002 may be performed by a device as described with reference to FIG. 1.

At 1004, the method may include transmitting a sidelink communication to a receiving UE based on a determination to transmit in a PSFCH occasion according to the PSSCH transmission in a RB set. The operations of 1004 may be performed in accordance with examples as described herein. In some implementations, aspects of the operations of 1004 may be performed by a device as described with reference to FIG. 1.

FIG. 11 illustrates a flowchart of a method 1100 that supports PSFCH resource configuration in accordance with aspects of the present disclosure. The operations of the method 1100 may be implemented by a device or its components as described herein. For example, the operations of the method 1100 may be performed by a UE 104, such as a sidelink transmitting UE, as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1102, the method may include transmitting to the receiving UE based on the determination to transmit in the PSFCH occasion in at least one RB set in a frequency domain according to a LBT result of the PSFCH transmission. The operations of 1102 may be performed in accordance with examples as described herein. In some implementations, aspects of the operations of 1102 may be performed by a device as described with reference to FIG. 1.

At 1104, the method may include transmitting to the receiving UE based on the determination to transmit in the PSFCH occasion in a lowest RB set index based on successful LBT for more than one RB set. The operations of 1104 may be performed in accordance with examples as described herein. In some implementations, aspects of the operations of 1104 may be performed by a device as described with reference to FIG. 1.

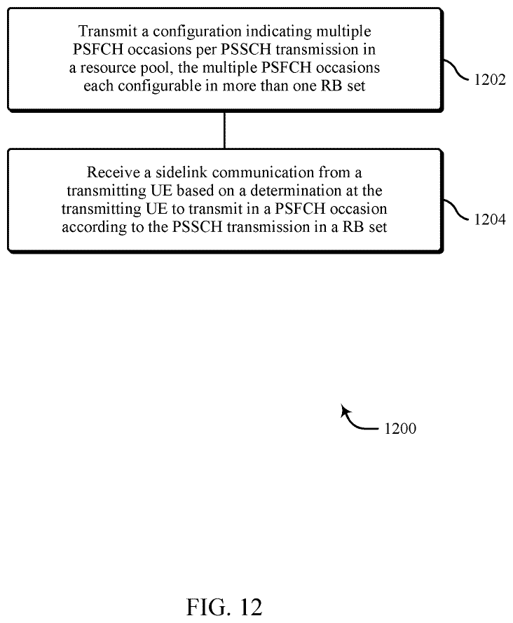

FIG. 12 illustrates a flowchart of a method 1200 that supports PSFCH resource configuration in accordance with aspects of the present disclosure. The operations of the method 1200 may be implemented by a device or its components as described herein. For example, the operations of the method 1200 may be performed by a UE 104, such as a sidelink receiving UE, as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1202, the method may include transmitting a configuration indicating multiple PSFCH occasions per PSSCH transmission in a resource pool, the multiple PSFCH occasions each configurable in more than one RB set. The operations of 1202 may be performed in accordance with examples as described herein. In some implementations, aspects of the operations of 1202 may be performed by a device as described with reference to FIG. 1.

At 1204, the method may include receiving a sidelink communication from a transmitting UE based on a determination at the transmitting UE to transmit in a PSFCH occasion according to the PSSCH transmission in a RB set. The operations of 1204 may be performed in accordance with examples as described herein. In some implementations, aspects of the operations of 1204 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements. The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a configuration indicating multiple physical sidelink feedback channel (PSFCH) occasions per physical sidelink shared channel (PSSCH) transmission in a resource pool, the multiple PSFCH occasions each configurable in more than one resource block (RB) set; and
transmit a sidelink communication to a receiving UE based at least in part on a determination to transmit in a PSFCH occasion according to the PSSCH transmission in a RB set.

2. The UE of claim 1, wherein the multiple PSFCH occasions are each configurable in more than one RB set in a frequency domain.

3. The UE of claim 1, wherein the multiple PSFCH occasions are each configurable in more than one RB set according to frequency division multiplexing (FDM).

4. The UE of claim 1, wherein the multiple PSFCH occasions are each configurable in more than one RB set in a time domain.

5. The UE of claim 1, wherein the multiple PSFCH occasions are each configurable in more than one RB set according to time division multiplexing (TDM).

6. The UE of claim 1, wherein the multiple PSFCH occasions are each configurable in more than one RB set according to frequency division multiplexing (FDM) and time division multiplexing (TDM) using more than one listen before talk (LBT) sub-band.

7. The UE of claim 1, wherein the multiple PSFCH occasions are each configurable in more than one RB set in a frequency domain and a time domain.

8. The UE of claim 1, wherein the determination to transmit in the PSFCH occasion is according to the PSSCH transmission in the RB set, a slot index, and a subchannel index.

9. The UE of claim 1, wherein the at least one processor is operable to cause the UE to transmit to the receiving UE based at least in part on the determination to transmit in the PSFCH occasion in at least one RB set in a frequency domain according to a listen before talk (LBT) result of the PSFCH transmission.

10. The UE of claim 1, wherein the at least one processor is operable to cause the UE to transmit to the receiving UE based at least in part on the determination to transmit in the PSFCH occasion in a lowest RB set index based on successful listen before talk (LBT) for more than one RB set.

11. A processor for wireless communication, comprising:
at least one controller coupled with at least one memory and operable to cause the processor to:
receive a configuration indicating multiple physical sidelink feedback channel (PSFCH) occasions per physical sidelink shared channel (PSSCH) transmission in a resource pool, the multiple PSFCH occasions each configurable in more than one resource block (RB) set; and
transmit a sidelink communication to a receiving user equipment (UE) based at least in part on a determination to transmit in a PSFCH occasion according to the PSSCH transmission in a RB set.

12. A user equipment (UE) for wireless communication, comprising:
at least one memory; and
at least one processor coupled with the at least one memory and operable to cause the UE to:
transmit a configuration indicating multiple physical sidelink feedback channel (PSFCH) occasions per physical sidelink shared channel (PSSCH) transmission in a resource pool, the multiple PSFCH occasions each configurable in more than one resource block (RB) set; and
receive a sidelink communication from a transmitting UE based at least in part on a determination at the transmitting UE to transmit in a PSFCH occasion according to the PSSCH transmission in a RB set.

13. The UE of claim 12, wherein the multiple PSFCH occasions are each configurable in more than one RB set in a frequency domain.

14. The UE of claim 12, wherein the multiple PSFCH occasions are each configurable in more than one RB set according to frequency division multiplexing (FDM).

15. The UE of claim 12, wherein the multiple PSFCH occasions are each configurable in more than one RB set in a time domain.

16. The UE of claim 12, wherein the multiple PSFCH occasions are each configurable in more than one RB set according to time division multiplexing (TDM).

17. The UE of claim 12, wherein the multiple PSFCH occasions are each configurable in more than one RB set according to frequency division multiplexing (FDM) and time division multiplexing (TDM) using more than one listen before talk (LBT) sub-band.

18. The UE of claim 12, wherein the multiple PSFCH occasions are each configurable in more than one RB set in a frequency domain and a time domain.

19. The UE of claim 12, wherein the determination to transmit in the PSFCH occasion is according to the PSSCH transmission in the RB set, a slot index, and a subchannel index.

20. A method performed by a user equipment (UE), comprising:
receiving a configuration indicating multiple physical sidelink feedback channel (PSFCH) occasions per physical sidelink shared channel (PSSCH) transmission in a resource pool, the multiple PSFCH occasions each configurable in more than one resource block (RB) set; and
transmitting a sidelink communication to a receiving UE based at least in part on a determination to transmit in a PSFCH occasion according to the PSSCH transmission in a RB set.
